(19) United States
(12) Patent Application Publication
(10) Pub. No.: US 2016/0327824 A1
(43) Pub. Date: Nov. 10, 2016

(54) DISPLAY PANEL

(71) Applicant: Au Optronics Corporation, Hsinchu (TW)

(72) Inventors: Yi-Jung Chen, Hsinchu City (TW); Shang-Jie Wu, Yunlin County (TW)

(21) Appl. No.: 14/845,296

(22) Filed: Sep. 4, 2015

(30) Foreign Application Priority Data
May 5, 2015 (TW) 104114252

(51) Int. Cl. G02F 1/1339; G02F 1/1362; G02F 1/1335; G09G 3/36; G02F 1/1368

(52) U.S. Cl. CPC G02F 1/13394; G09G 3/3674; G09G 3/3685; G09G 3/3648; G02F 1/1368; G02F 1/133514; G02F 1/133512; G02F 1/136286; G09G 2300/0426

(57) ABSTRACT

A display panel includes a first substrate, color filter patterns, a black matrix layer, spacers, a second substrate, and a display medium. The first substrate has a pixel array including scans lines, data lines, pixel structures, and signal lines. The color filter patterns having a recess portion and a protrusion portion are located on the first substrate. The protrusion portion of each color filter pattern extends to the recess portion of another color filter pattern of the adjacent pixel area. The black matrix layer and the spacers are located on the first substrate and the color filter patterns. The black matrix layer is disposed corresponding to the scan lines and the data lines. The spacers are correspondingly located on the protrusion portion. The second substrate is on the opposite side of the first substrate. The display medium is located between the black matrix layer and the second substrate.

### CROSS-REFERENCE TO RELATED APPLICATION

This application claims the priority benefit of Taiwan application serial no. 104114252, filed on May 5, 2015. The entirety of the above-mentioned patent application is hereby incorporated by reference herein and made a part of this specification.

1. Field of the Invention

The invention relates to a display panel, and more particularly, to a display panel having spacers that are arranged in cross regions between signal lines and data lines.

2. Description of Related Art

With advantages of high definition, small volume, light weight, low driving voltage, low power consumption, and a wide range of applications, liquid crystal displays (LCD) have replaced cathode ray tube (CRT) displays and have become the mainstream display product in the next generation. Moreover, flat panel displays characterized by light weight and compactness are currently arranged on non-planar surfaces of buildings or electronic equipment.

In a conventional LCD panel, spacers are often arranged to separate the upper substrate and the lower substrate of the display panel from each other by a cell gap. The spacers, however, may pose an impact on the orientation of the surrounding liquid crystal and thus deteriorate the liquid crystal efficiency and the display quality. In another aspect, curved display panels have also been vigorously developed. Nevertheless, in process of manufacturing the curved display panel, while the curved surfaces of the upper and lower substrates are being assembled, the spacers may scratch surfaces of other film layers, such that light leakage occurs in the display panel, and that the display quality of the display panel is no longer satisfactory.

### SUMMARY OF THE INVENTION

The invention is directed to a display panel capable of resolving issues arising from spacers of a conventional LCD panel.

In an embodiment of the invention, a display panel that includes a first substrate, a plurality of color filter patterns, a black matrix layer, a plurality of spacers, a second substrate, and a display medium is provided. The first substrate has a pixel array that includes a plurality of scans lines, a plurality of data lines, a plurality of pixel structures, and a plurality of signal lines. Two adjacent scan lines of the scan lines and two adjacent data lines of the data lines define one pixel area. The pixel structures are electrically connected to the scan lines and the data lines, and each of the pixel structures includes a switch device and a pixel electrode. The signal lines are arranged corresponding to the pixel structures, and extension directions of the signal lines are different from extension directions of the data lines. The color filter patterns are arranged on the first substrate. Here, each of the color filter patterns is arranged corresponding to one of the pixel areas, each of the color filter patterns having a recess portion and a protrusion portion, and the protrusion portion of each of the color filter patterns extends to the recess portion of another of the color filter patterns of the adjacent pixel area. The black matrix layer is arranged on the first substrate and located on the color filter patterns, and the black matrix layer is arranged corresponding to the scan lines and the data lines. The spacers are arranged on the first substrate and located on the color filter patterns, and the spacers are correspondingly arranged on the protrusion portions of the color filter patterns. The second substrate is on the opposite side of the first substrate. The display medium is located between the black matrix layer and the second substrate.

In light of the above, the spacers are located in cross regions (i.e., the non-transparent regions) between the data lines and the signal lines, which increases the aperture ratio of the display panel. Besides, since the spacers are located in the non-transparent regions, the light leakage arising from the spacers scratching other film layers can be blocked effectively.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1A is a schematic top view illustrating a display panel according to an embodiment of the invention.

FIG. 1B is a schematic top view illustrating the color filter patterns depicted in FIG. 1A.

FIG. 2 is a schematic cross-sectional view taken along a sectional line A-A′ depicted in FIG. 1A.

FIG. 3 is a schematic cross-sectional view taken along a sectional line B-B′ depicted in FIG. 1A.

FIG. 4 is a schematic cross-sectional view illustrating a display panel taken along a section line A-A′ depicted in FIG. 1A according to an embodiment of the invention.

FIG. 5 is a schematic cross-sectional view illustrating a display panel taken along a section line B-B′ depicted in FIG. 1A according to an embodiment of the invention.

FIG. 6 is a schematic top view illustrating a display panel according to another embodiment of the invention.

### DETAILED DESCRIPTION OF DISCLOSED EMBODIMENTS

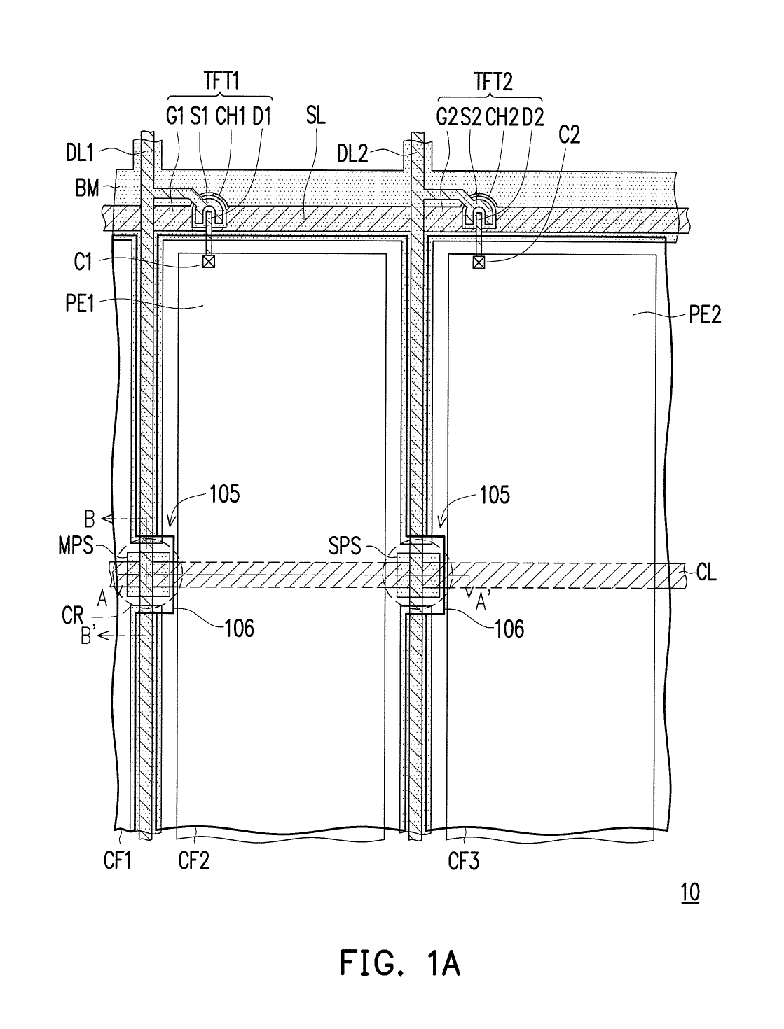

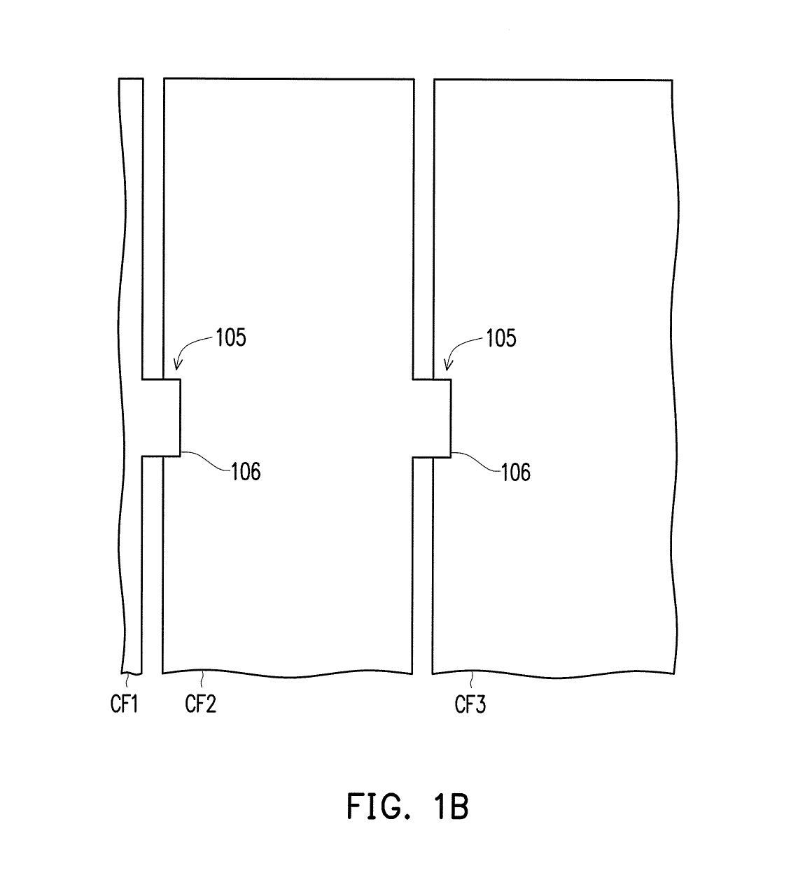

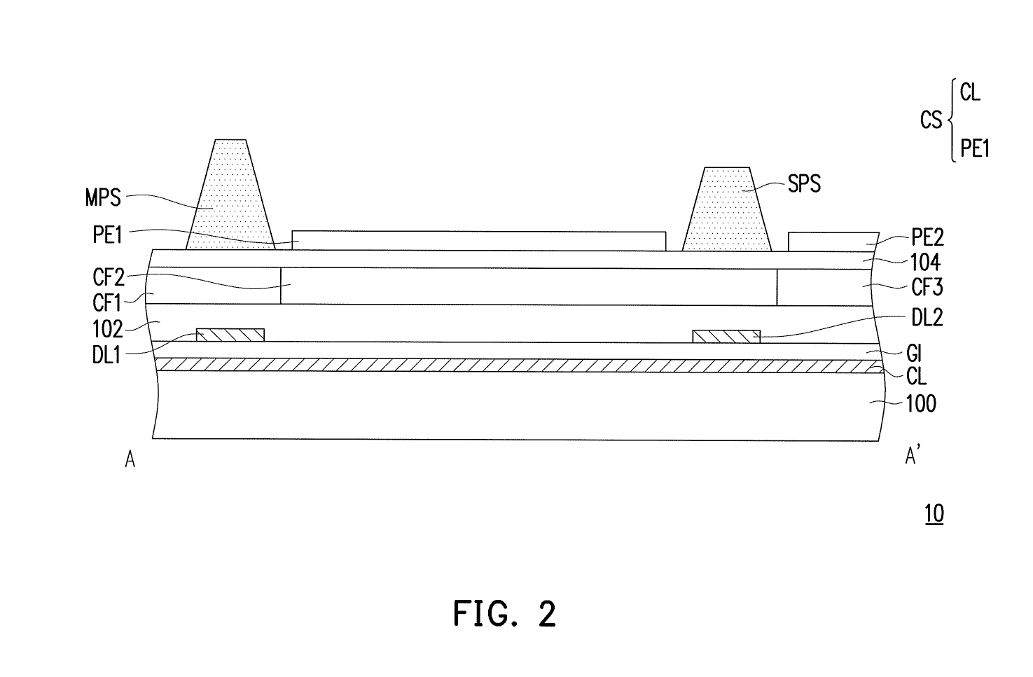

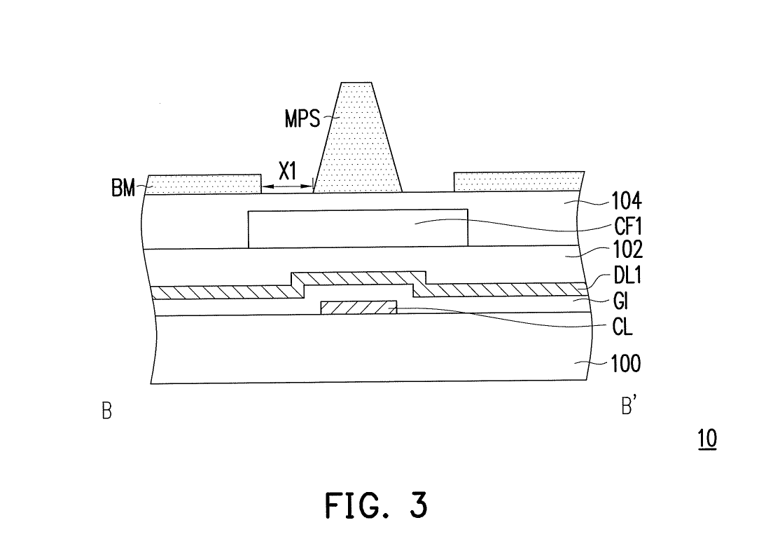

FIG. 1A is a schematic top view illustrating a display panel 10 according to an embodiment of the invention. To clearly illustrate the devices on the display panel 10, the substrate, the opposite substrate, and the display medium of the display panel 10 are not depicted in FIG. 1A. FIG. 2 is a schematic cross-sectional view taken along a sectional line A-A′ depicted in FIG. 1A. FIG. 3 is a schematic cross-sectional view taken along a sectional line B-B′ depicted in FIG. 1A.

With reference to FIG. 1A, FIG. 2, and FIG. 3, a first substrate 100 is provided. The first substrate 100 may be made of glass, quartz, organic polymer, metal, and so forth. Scan lines SL, signal lines CL, and gates G1-G2 are formed on the first substrate 100. That is, the scan lines SL, the signal lines CL, and the gates G1-G2 are in the same film layer. In the present embodiment, extension directions of the scan lines SL are the same as extension directions of the signal lines CL, which should not be construed as a limitation to the invention. In another embodiment, the extension directions of the scan lines SL may be different from the extension directions of the signal lines CL. The scan lines SL, the signal lines CL, and the gates G1-G2 are often made of metallic materials. However, the invention is not limited thereto. According to another embodiment, the scan lines SL, the signal lines CL, and the gates G1-G2 may also be made of other conductive materials, such as an alloy, a metal nitride material, a metal oxide material, a metal oxynitride material, or a stacked layer having the metallic materials and other conductive materials.

A gate insulation layer GI is formed on the scan lines SL, the signal lines CL, and the gates G1-G2, as shown in FIG. 2 and FIG. 3. A material of the gate insulation layer GI includes an inorganic material (e.g., silicon oxide, silicon nitride, silicon oxynitride, any other suitable material, or a stacked layer containing at least two of the above materials), an organic material, any other suitable material, or a combination of the above. Channel layers CH1-CH2 are then formed on the gate insulation layer GI; a material of the channel layers CH1-CH2 may be selected from amorphous silicon, polysilicon, or an oxide semiconductor material, which should however not be construed as a limitation to the invention.

Data lines DL1-DL2, sources S1-S2, and drains D1-D2 are formed on the gate insulation layer GI and the channel layers CH1-CH2. In the present embodiment, the data lines DL1-DL2, the sources S1-S2, and the drains D1-D2 are in the same film layer. The scan lines SL and the data lines DL1-DL2 are interlaced. In other words, extension directions of the data lines DL1-DL2 are not parallel to the extension directions of the scan lines SL; preferably, the extension directions of the scan lines SL are perpendicular to the extension directions of the data lines DL1-DL2. By contrast, the extension directions of the signal lines CL are different from the extension directions of the data lines DL1-DL2. The material of the data lines DL1-DL2 may be the same as or different from the material of the scan lines SL. Specifically, the data lines DL1-DL2 are often made of metallic materials. However, the data lines DL1-DL2 can also be made of other conductive materials according to other embodiments, which should not be construed as a limitation to the invention. For instance, the data lines DL1-DL2 may be made of an alloy, a metal nitride material, a metal oxide material, a metal oxynitride material, a stacked layer having metallic materials and other conductive materials, or any other appropriate material. In the present embodiment, two adjacent scan lines SL and two adjacent data line DL1-DL2f define one pixel area (not shown).

The gates G1-G2, the sources S1-S2, the drains D1-D2, and the channel layers CH1-CH2 constitute a first active device TFT1 and a second active device TFT2. Specifically, the gate G1, the source S1, the drain D1, and the channel layer CH1 constitute the first active device TFT1, and the gate G2, the source S2, the drain D2, and the channel layer CH2 constitute the second active device TFT2. Here, the gates G1-G2 are electrically connected to the scan lines SL, the source S1 is electrically connected to the data line DL1, and the source S2 is electrically connected to the data line DL2.

An insulation layer 102 is formed on the data lines DL1-DL2, the sources S1-S2, and the drains D1-D2, as shown in FIG. 2 and FIG. 3. The material of the insulation layer 102 can be the same as or different from the material of the gate insulation layer GI. For instance, the material of the insulation layer 102 includes an inorganic material (e.g., silicon oxide, silicon nitride, silicon oxynitride, any other suitable material, or a stacked layer containing at least two of the above materials), an organic material, any other suitable material, or a combination of the above.

With reference to FIG. 1A to FIG. 3, color filter patterns CF1-CF3 are formed on the insulation layer 102. Each of the color filter patterns CF1-CF3 is arranged corresponding to one of the pixel areas. That is, as illustrated in FIG. 1A and FIG. 1B, in the present embodiment, the color filter patterns CF1-CF3 are respectively arranged in three different pixel areas. The color filter patterns CF1-CF3 can be red, green, and blue filter patterns, respectively, which should however not be construed as a limitation to the invention. In particular, each of the color filter patterns CF1-CF3 has a recess portion 105 and a protrusion portion 106, and the protrusion portion of each of the color filter patterns CF1-CF3 extends to the recess portion 105 of another of the color filter patterns CF1-CF3 of the adjacent pixel area. For instance, as shown in FIG. 1B, the protrusion portion 106 of the color filter pattern CF2 extends to the recess portion 105 of the color filter pattern CF3 of the adjacent pixel area. Namely, the protrusion portion 106 of the color filter pattern CF2 is substantially the recess portion 105 of the color filter pattern CF3, i.e., the protrusion portion 106 of the color filter pattern CF2 is embedded into the recess portion 105 of the color filter pattern CF3, and the protrusion portion 106 of the color filter pattern CF1 is embedded into the recess portion 105 of the color filter pattern CF2. Similarly, the protrusion portion 106 of the color filter pattern CF3 is embedded into the recess portion 105 of the color filter pattern CF1.

Particularly, a cross region CR is located between each of the signal lines CL and one of the data lines DL1-DL2, and the recess portion 105 and the corresponding protrusion portion 106 of each of the color filter patterns CF1-CF3 are arranged in the cross region CR. Note that the active devices TFT1-TFT2 and the color filter patterns CF1-CF3 are arranged on the first substrate 100 according to the present embodiment, and therefore the display panel provided in the present embodiment has a color-filter-on-array (COA) structure.

With reference to FIG. 2 and FIG. 3, a passivation layer 104 is formed on the color filter patterns CF1-CF3. The material of the passivation layer 104 can be the same as or different from the material of the insulation layer 102. For instance, the material of the passivation layer 104 includes an inorganic material (e.g., silicon oxide, silicon nitride, silicon oxynitride, any other suitable material, or a stacked layer containing at least two of the above materials), an organic material, any other suitable material, or a combination of the above.

Pixel electrodes PE1-PE2 are then formed on the passivation layer 104. The pixel electrodes PE1-PE2 may be transmissive pixel electrodes, reflective pixel electrodes, or transflective pixel electrodes. A material of the transmissive pixel electrodes may include metal oxide, such as indium tin oxide (ITO), indium zinc oxide (IZO), aluminum tin oxide (ATO), aluminum zinc oxide (AZO), indium germanium zinc oxide, other suitable oxides, or a stacked layer having at least two of the above materials. The reflective pixel electrodes are made of a metallic material that is characterized by high reflectivity.

As shown in FIG. 1A, the first pixel electrode PE1 is electrically connected to the drain D1 of the first active device TFT1 through the first contact window C1 (penetrating the passivation layer 104, the color filter patterns CF1-CF3, and the insulation layer 102), and the second pixel electrode PE2 is electrically connected to the drain D2 of the second active device TFT2 through the second contact window C2 (penetrating the passivation layer 104, the color filter patterns CF1-CF3, and the insulation layer 102). According to the present embodiment, the first pixel electrode PE1 and the first active device TFT1 constitute an independent pixel structure, and the second pixel electrode PE2 and the second active device TFT2 constitute another independent pixel structure. On the other hand, the scan lines SL, the data lines DL1-DL2, the pixel structures, and the signal lines CL constitute a pixel array.

According to the present embodiment, the signal lines CL may be common voltage lines, which should not be construed as a limitation to the invention. That is, in the present embodiment, the signal lines CL can be electrically connected to a common voltage. With reference to FIG. 1A and FIG. 2, according to the present embodiment, the signal lines CL and the pixel electrodes PE1-PE2 are overlapped; hence, if the signal lines CL are the common voltage lines, the common voltage lines and the pixel electrodes PE1-PE2 may constitute storage capacitors CS.

The black matrix layer BM and spacers MPS and SPS are then formed on the passivation layer 104. That is, the black matrix layer BM and the spacers MPS and SPS are arranged on the first substrate 100 and located above the color filter patterns CF1-CF3. In the present embodiment, the black matrix layer BM and the spacers MPS and SPS are formed by using one photomask and are made of the same material, and therefore the black matrix layer BM and the spacers MPS and SPS are in the same film layer; i.e., the black matrix layer BM and the spacers MPS and SPS have non-transparent colors, e.g., black or gray. With reference to FIG. 1A, the black matrix layer BM is arranged corresponding to the scan lines SL and the data lines DL1-DL2, and the spacers MPS and SPS are correspondingly arranged on the protrusion portions 106 of the color filter patterns CF1-CF3. Since the protrusion portions 106 of the color filter patterns CF1-CF3 are located in the cross region CR, the spacers MPS and SPS are also arranged in the cross region CR.

Note that the spacers shown in FIG. 2 include a plurality of main spacers MPS and a plurality of sub-spacers SPS, and heights of the main spacers MPS are greater than heights of the sub-spacers SPS.

Moreover, in the present embodiment, the spacers MPS and SPS are separated from the black matrix layer BM, whereas the invention is not limited thereto. In another embodiment of the invention, the spacers MPS and SPS may be connected to the black matrix layer BM. In particular, there is a minimum distance X1 between the spacers MPS and SPS and the black matrix layer BM. The minimum distance X1 may be 0 μm-14 μm; therefore, if the minimum distance X1 is 0 μm, the spacers MPS and SPS are substantially connected to the black matrix layer BM. Besides, the height of the black matrix layer BM is less than the height of the sub-spacers SPS.

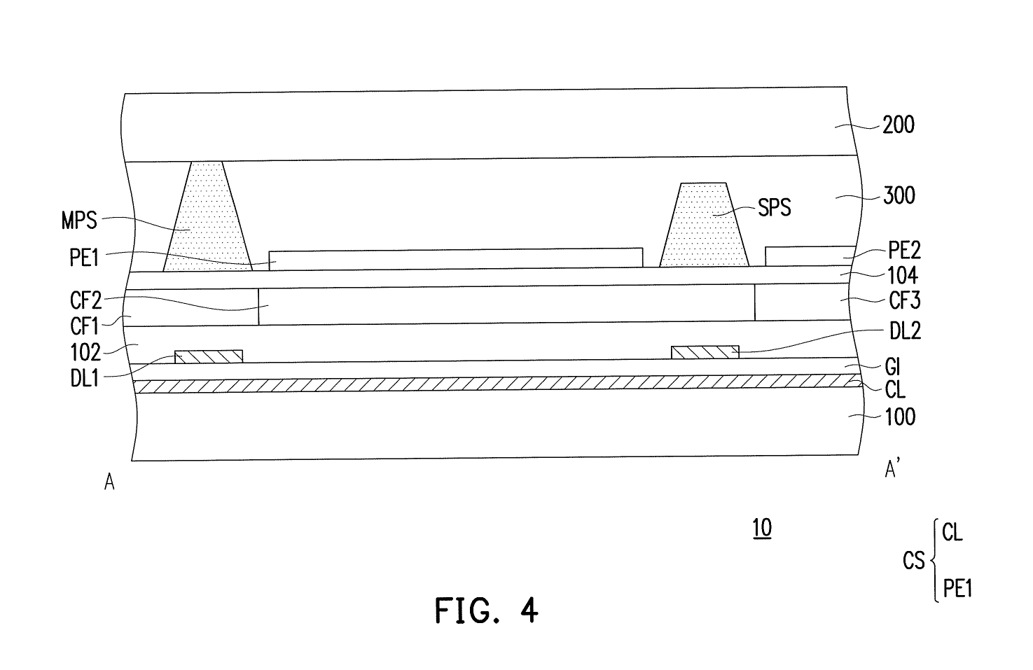

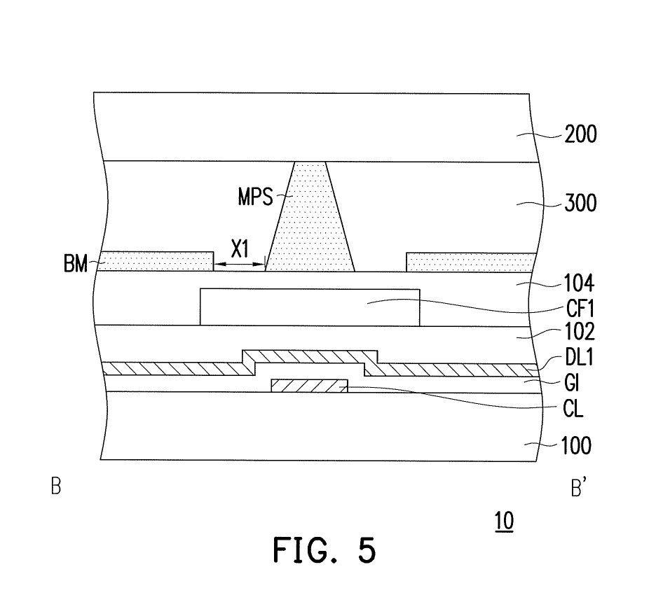

FIG. 4 is a schematic cross-sectional view illustrating a display panel taken along a section line A-A′ depicted in FIG. 1A according to an embodiment of the invention. FIG. 5 is a schematic cross-sectional view illustrating a display panel taken along a section line B-B′ depicted in FIG. 1A according to an embodiment of the invention.

With reference to FIG. 4 and FIG. 5, after the steps shown in FIG. 2 and FIG. 3 are completed, a second substrate 200 is provided. The second substrate 200 is on the opposite side of the first substrate 100, and a display medium 300 is injected between the first substrate 100 and the second substrate 200, so as to complete the display panel 10 provided herein. Specifically, the material of the second substrate 200 may be the same as or different from that of the first substrate 100. For instance, the second substrate 200 may be made of glass, quartz, organic polymer, metal, and so forth. The display medium 300 may include liquid crystal molecules, an electrophoretic display medium, or any other suitable display medium.

In the present embodiment, the spacers MPS and SPS are located in the cross regions CR between the signal lines CL and the data lines DL1-DL2, and thus the spacers MPS and SPS are located in the non-transparent regions. According to the related art, the spacers are located in the transparent regions; in comparison, the aperture ratio of the display panel can be raised according to the present embodiment. Besides, if the spacers MPS and SPS scratch other film layers and thus cause light leakage during the assembly of the display panel, the light leakage can be blocked effectively, so as to prevent the display quality from being deteriorated. From another perspective, according to the present embodiment, the spacers MPS and SPS are arranged on the protrusion portions 106 of the color filter patterns CF1-CF3, and the spacers MPS and SPS and the protrusion portions 106 of the color filter patterns CF1-CF3 are completely overlapped; therefore, the relatively flat protrusion portions 106 of the color filter patterns CF1-CF3 allow the spacers MPS and SPS to be formed on a planar region rather than on the intersection of at least two stacked color filter patterns; as such, the thickness of the spacers MPS and SPS at the same location is uniform, and the yield of the spacers MPS and SPS can be improved. Moreover, since the spacers MPS and SPS are arranged on the protrusion portions 106 of the color filter patterns CF1-CF3, and the spacers MPS and SPS and the protrusion portions 106 of the color filter patterns CF1-CF3 are completely overlapped, the liquid crystal molecules around the spacers MPS and SPS can be rapidly oriented in a normal manner, so as to ameliorate the liquid crystal efficiency.

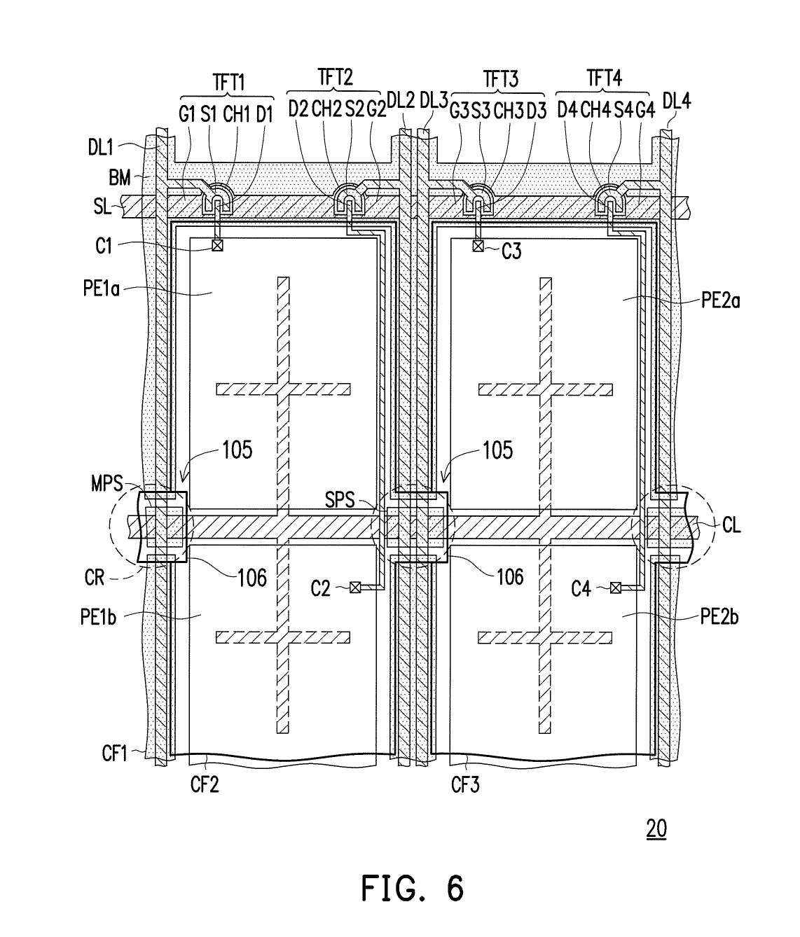

FIG. 6 is a schematic top view illustrating a display panel 20 according to another embodiment of the invention. To clearly illustrate the devices on the display panel 20, the substrate, the opposite substrate, and the display medium of the display panel 20 are not depicted in FIG. 6. The display panel 20 provided in the present embodiment is similar to the display panel depicted in FIG. 1A, and therefore identical devices in these figures will be denoted with the same numerals and will not be further described hereinafter. The difference between the two embodiments respectively shown in FIG. 6 and FIG. 1A lies in that two data lines DL2 and DL3 are arranged between two adjacent pixel structures, and the protrusion 106 of each of the color filter patterns CF1-CF3 and two of the data lines DL2 and DL3 between two adjacent pixel structures are overlapped. In addition, each pixel structure includes main pixel electrodes PE1a and PE2a and sub-pixel electrodes PE1b and PE2b, and the switch device in each pixel structure respectively includes two active devices TFT1 and TFT2 and two active devices TFT3 and TFT4.

Specifically, the first active device TFT1 and the second active device TFT2 are both electrically connected to the scan lines SL, and each of the first active device TFT1 and the second active device TFT2 is electrically connected to different data lines DL1-DL2, respectively. The first active device TFT1 is electrically connected to the data line DL1, and the second active device TFT2 is electrically connected to the data line DL2. The third active device TFT3 and the fourth active device TFT4 are both electrically connected to the scan lines SL, the third active device TFT3 is electrically connected to the data line DL3, and the fourth active device TFT4 is electrically connected to the data line DL4. The drain D1 of the first active device TFT 1 is electrically connected to the first main pixel electrode PE1a through the first contact window Cl, and the drain D2 of the second active device TFT2 is electrically connected to the first sub-pixel electrode PE1b through the second contact window C2. The drain D3 of the third active device TFT3 is electrically connected to the second main pixel electrode PE2a through the third contact window C3, and the drain D4 of the fourth active device TFT4 is electrically connected to the second sub-pixel electrode PE2b through the fourth contact window C4. That is, compared to the 1D1G structure depicted in FIG. 1, the 2D1G structure is provided in the present embodiment.

As described in the embodiment illustrated in FIG. 1A, in the present embodiment, the spacers MPS and SPS are located in the cross regions CR between the signal lines CL and the data lines DL1-DL4; therefore, if the spacers MPS and SPS scratch other film layers and thus cause light leakage, the light leakage can be blocked effectively. From another perspective, according to the present embodiment, the spacers MPS and SPS are arranged on the protrusion portions 106 of the color filter patterns CF1-CF3, and the spacers MPS and SPS and the protrusion portions 106 of the color filter patterns CF1-CF3 are completely overlapped; therefore, the relatively flat protrusion portions 106 of the color filter patterns CF1-CF3 allow the spacers MPS and SPS to be formed on a planar region rather than on the intersection of at least two stacked color filter patterns; as such, the thickness of the spacers MPS and SPS at the same location is uniform, and the yield of the spacers MPS and SPS can be improved. Moreover, since the spacers MPS and SPS are arranged on the protrusion portions 106 of the color filter patterns CF1-CF3, and the spacers MPS and SPS and the protrusion portions 106 of the color filter patterns CF1-CF3 are completely overlapped, the liquid crystal molecules around the spacers MPS and SPS can be rapidly oriented in a normal manner, so as to ameliorate the liquid crystal efficiency.

To sum up, the spacers are located in cross regions (i.e., the non-transparent regions) between the data lines and the signal lines, which increases the aperture ratio of the display panel. Besides, since the spacers are located in the non-transparent regions, the light leakage arising from the spacers scratching other film layers can be blocked effectively. In another aspect, each of the color filter patterns has a recess portion and a protrusion portion, the protrusion portion of each of the color filter patterns extends to the recess portion of another of the color filter patterns of the adjacent pixel area, and the spacers are located in the protrusion portions. As the spacers provided herein are arranged on the protrusion portions rather than on the intersection of at least two stacked color filter patterns, the thickness of the spacers at the same location is uniform, and the yield of the spacers can be improved. Moreover, since the spacers are arranged on the protrusion portions of the color filter patterns, and the spacers and the protrusion portions of the color filter patterns are completely overlapped, the liquid crystal molecules around the spacers can be rapidly oriented in a normal manner, so as to ameliorate the liquid crystal efficiency.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A display panel comprising:
a first substrate having a pixel array, the pixel array comprising:
a plurality of scan lines and a plurality of data lines, two adjacent scan lines of the scan lines and two adjacent data lines of the data lines defining one pixel area;
a plurality of pixel structures electrically connected to the scan lines and the data lines, wherein each of the pixel structures comprises a switch device and a pixel electrode; and
a plurality of signal lines arranged corresponding to the pixel structures, extension directions of the signal lines being different from extension directions of the data lines;
a plurality of color filter patterns arranged on the first substrate, wherein each of the color filter patterns is arranged corresponding to one of the pixel areas, each of the color filter patterns having a recess portion and a protrusion portion, the protrusion portion of each of the color filter patterns extending to the recess portion of another of the color filter patterns of the adjacent pixel area;
a black matrix layer arranged on the first substrate and located on the color filter patterns, the black matrix layer being arranged corresponding to the scan lines and the data lines;
a plurality of spacers arranged on the first substrate and located on the color filter patterns, the spacers being correspondingly arranged on the protrusion portions of the color filter patterns;
a second substrate located on an opposite side of the first substrate; and
a display medium located between the black matrix layer and the second substrate.

2. The display panel of claim 1, wherein a cross region is located between each of the signal lines and one of the data lines, and the protrusion portion of each of the color filter patterns is arranged in the cross region.

3. The display panel of claim 1, wherein a cross region is located between each of the signal lines and one of the data lines, and the recess portion of each of the color filter patterns is arranged in the cross region.

4. The display panel of claim 1, wherein the extension directions of the signal lines are the same as extension directions of the scan lines.

5. The display panel of claim 4, wherein the signal lines comprise common voltage lines, and the common voltage lines and the pixel electrodes are overlapped to constitute a plurality of pixel storage capacitors.

6. The display panel of claim 1, wherein the spacers and the protrusion portions of the color filter patterns are completely overlapped.

7. The display panel of claim 1, wherein a material of the spacers is the same as a material of the black matrix layer, and the spacers and the black matrix layer are in one film layer.

8. The display panel of claim 7, wherein the spacers are separated from the black matrix layer.

9. The display panel of claim 7, wherein a minimum distance between the spacers and the black matrix layer is 0 μm-14 μm.

10. The display panel of claim 1, wherein the spacers comprise a plurality of main spacers and a plurality of sub-spacers, and heights of the main spacers are greater than heights of the sub-spacers.

11. The display panel of claim 1, wherein
the switch device of each of the pixel structures comprises a first active device and a second active device,
the pixel electrode of each of the pixel structures comprises a main pixel electrode and a sub-pixel electrode, the main pixel electrode is electrically connected to the first active device, the sub-pixel electrode is electrically connected to the second active device,
the first active device and the second active device are both electrically connected to one of the scan lines, each of the first active device and the second active device is electrically connected to one of the data lines, respectively,
two data lines of the data lines are arranged between two adjacent pixel structures of the pixel structures, and
the protrusion portion of each of the color filter patterns and two of the data lines are overlapped.
